(19) United States
(12) Patent Application Publication
(10) Pub. No.: US 2007/0259706 A1
(43) Pub. Date: Nov. 8, 2007

(54) Wagering Game With Board-Game Feature For Payoffs

(75) Inventors: Peter R. Anderson, Chicago, IL (US); Allon G. Englman, Chicago, IL (US); Jeremy M. Hornik, Chicago, IL (US); Michael W. Mastropietro, Chicago, IL (US)

Correspondence Address: NIXON PEABODY LLP, 161 N. CLARK STREET, 48TH FLOOR, CHICAGO, IL, 60601-3213, US

(73) Assignee: WMS GAMING INC., Waukegan, IL (US)

(21) Appl. No.: 11/574,112

(22) PCT Filed: Aug. 22, 2005
(86) PCT No.: PCT/US05/29860

§ 371 Date: Feb. 22, 2007

Related U.S. Application Data
(60) Provisional application No. 60/604,833, filed on Aug. 25, 2004.

(51) Int. Cl. G07F 17/32

(52) U.S. Cl. 463/16

(57) ABSTRACT

The present invention is directed to a gaming terminal and a method of playing a wagering game. The wagering game may include a basic game and a bonus game having a board-game theme. The basic game has a plurality of randomly selected outcomes, one of the outcomes includes assets of the board game that are accumulated by a player. The accumulation of assets is affected by the randomly selected outcomes in the basic game. The basic game and the bonus game may award a bonus based on the assets accumulated by the player. Before terminating the gaming session, the player has the option of saving the accumulated assets in a memory device at the gaming terminal for use in a subsequent gaming session.

### FIELD OF THE INVENTION

The present invention relates generally to gaming terminals and, more particularly, to a gaming terminal having a board game theme whereby assets associated with the board game are accumulated and saved at the gaming terminal and can be restored at a subsequent gaming session.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

In current basic games, bonus games, and progressive games, the player is provided with little incentive to return to the game at a later time. Once the player chooses to stop playing the game in that round, the player is immediately awarded any credits that are remaining and also loses assets that have been accumulated, but not yet awarded. For example, in some games, the bonus game consists of the player collecting assets and when a certain number or combination of assets is accumulated, the player wins an award. However, should the player choose to leave the game prior to winning the award, the player loses all of the assets accumulated. This can cause player frustration and does not provide the player with any incentive to return to the game.

Such a system also encourages “vulturing,” in which the “vulturing” player waits for a person who is close to winning an award to leave the gaming machine prior to the winning of the award. The “vulturing” player then begins to play the machine, and may quickly win the award without investing much time into the game. This is also frustrating for other players.

Thus, there is a need to allow a player to accumulate assets on gaming terminals and to have those assets restored to them should the player return to the game at a later time. This way, should a player choose to leave a game, anything the player has accumulated during the game goes with them and is restored at a later time when the player returns to the game. This alleviates the player frustration at losing assets that they have accumulated and also provides the player with an incentive to return to the game at a later date.

### SUMMARY OF THE INVENTION

In one aspect of the present invention, a gaming terminal for playing a wagering game includes a basic game that has a plurality of symbols indicating a randomly selected outcome. The randomly selected outcome is selected from a plurality of outcomes in response to a wager input by a player. The plurality of outcomes includes assets of a board game that are accumulated by a player of the basic game. The wagering game also includes a bonus game having a bonus award based on an accumulation of at least one of the assets. The accumulation of assets is affected by the randomly selected outcomes in the basic game. In response to the termination of a gaming session, the accumulated assets are selectively stored by a player in a memory device for use in a subsequent gaming session by the player.

In another aspect of the present invention, a method of playing a wagering game having a basic game and a bonus game includes conducting the basic game at a gaming terminal. The basic game has a plurality of symbols that indicate a randomly selected outcome that has been selected from a plurality of outcomes in response to a wager input. The plurality of outcomes includes assets of a board game that are accumulated by a player of the basic game. If a bonus-game outcome is achieved in the basic game, a bonus game provides a bonus award based on the accumulation of assets during the basic game. Based on inputs received from the player, the assets are saved prior to the player completing the gaming session and are stored in a memory device for use in a subsequent gaming session.

In an alternative aspect of the present invention, a gaming terminal for playing a wagering game includes a display for displaying at least one randomly selected outcome that has been selected from a plurality of outcomes in response to a wager input from a player. The plurality of outcomes includes assets associated with a board game that are accumulated by the player while playing the wagering game. A controller is coupled to the display and operates to store the assets accumulated by the player in a memory device for use in a subsequent gaming session.

In an alternative aspect of the present invention, a gaming terminal for playing a wagering game includes a plurality of symbols having a board game theme. The plurality of symbols indicate a randomly selected outcome of the wagering game. The randomly selected outcome is selected from a plurality of outcomes in response to a wager input from a player. The wagering game includes an award based on the randomly selected outcome. The award is associated with at least one of a plurality of assets of the board game. The assets are selectively stored by the player in a memory device for use in a subsequent gaming session.

In an alternative aspect of the present invention, a method for conducting a wagering game includes receiving a wager input from a player for playing a wagering game during a first gaming session. The wagering game has a board game theme. At least one randomly-selected outcome of a plurality of outcomes is selected in response to receiving the wager input. The player acquires at least one of a plurality of assets associated with the board game and selectively stores the asset(s) in a memory device for use in a second gaming session. The assets from the first gaming session are later restored for use in the second gaming session.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a gaming terminal according to one embodiment of the present invention.

FIG. 2 is a block diagram of the gaming terminal of FIG. 1.

FIG. 3 represents a main and secondary display of the gaming terminal of FIG. 1 having a wagering game with a board game theme according to one embodiment of the present invention.

FIG. 4 represents a main and secondary display of the gaming terminal of FIG. 1 having a wagering game with a board game theme depicting a winning outcome according to another embodiment of the present invention.

FIG. 5 represents a main and secondary display of the gaming terminal of FIG. 1 having a wagering game with a board game theme depicting a winning outcome according to another embodiment of the present invention.

FIG. 6 represents a main and secondary display of the gaming terminal of FIG. 1 having a wagering game with a board game theme depicting a bonus-game outcome according to another embodiment of the present invention.

FIG. 7 represents a main and secondary display of the gaming terminal of FIG. 1 having a wagering game with a board game theme depicting a bonus-game outcome according to another embodiment of the present invention.

FIG. 8 represents a main and secondary display of the gaming terminal of FIG. 1 having a wagering game with a board game theme depicting a progressive-award outcome according to another embodiment of the present invention.

FIG. 9 represents a main and secondary display of the gaming terminal of FIG. 1 having a wagering game with a board game theme depicting a player-vs.-computer outcome according to another embodiment of the present invention

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

The present invention is directed to a gaming terminal and a method of playing a wagering game. The wagering game may include a basic game and a bonus game. Both the basic game and the bonus game have a board-game theme, i.e. a Monopoly™ game. Along with this theme, a player accumulates assets that are associated with the board game, such as properties, railroad, and utilities. The accumulation of assets is affected by the randomly selected outcomes in the basic game. These outcomes are controlled by a processor or controller that performs random selections, thereby allowing the board game to be conducted as part of a wagering game. Before terminating a gaming session, the player has the option of saving the accumulated assets in a memory device at the gaming terminal for use in a subsequent gaming session.

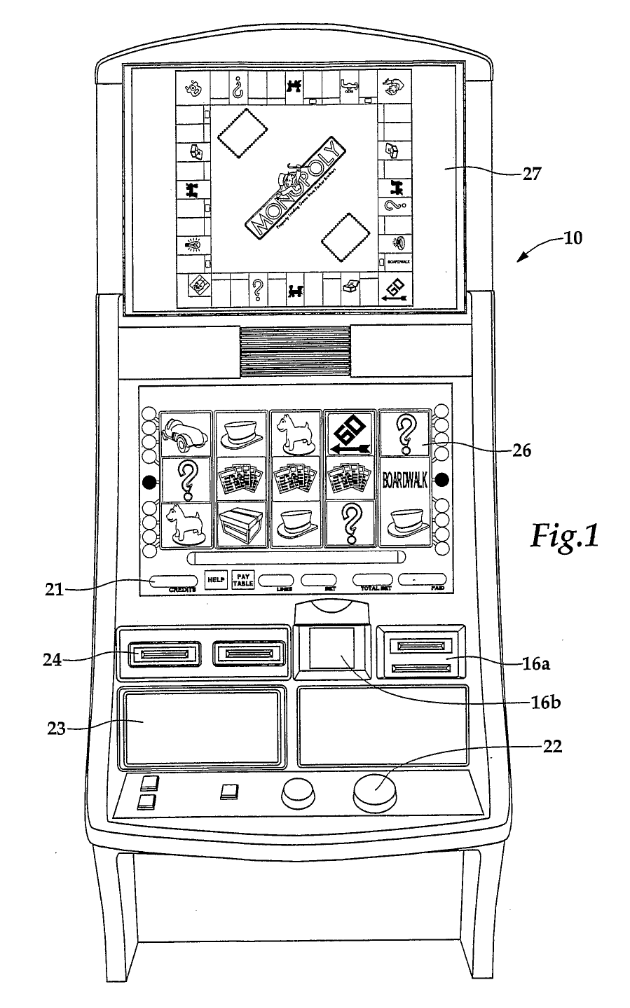

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video slots or a video casino game, such as blackjack, slots, keno, poker, etc.

As shown, the gaming terminal 10 includes input devices, such as a wager acceptor 16 (shown as a card wager acceptor 16a and a cash wager accepter 16b), a touch screen 21, a push-button panel 22, and an information reader 24. For outputs, the gaming terminal 10 includes a payout mechanism 23, a main display 26 for displaying information about the basic wagering game, and a secondary display 27 that may display an electronic version of a pay table, information about a bonus game, and/or also possibly game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

Also included is the payout mechanism 23, which performs the reverse functions of the wager acceptor. For example, the payout mechanism 23 may include a coin dispenser or a note dispenser to output value from gaming terminal 10. Also, the payout mechanism 23 may also be adapted to receive a card that authorizes the gaming terminal to transfer credits from the gaming terminal 10 to a central account.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome, as well. The secondary display 27 may display information relating to the basic wagering game or a bonus game. Like the main display 26, the secondary display 27 may take the form of a cathode ray tube (CRT), a high resolution LCD, a plasma display, LED, or any other type of video display suitable for use in the gaming terminal 10.

In some embodiments, the information reader 24 is a card reader that allows for identification of a player by reading a card with information indicating his or her true identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10. The information reader 24 may also include a keypad (not shown) for entering a personal identification number (PIN). The gaming terminal 10 may require that the player enter their PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

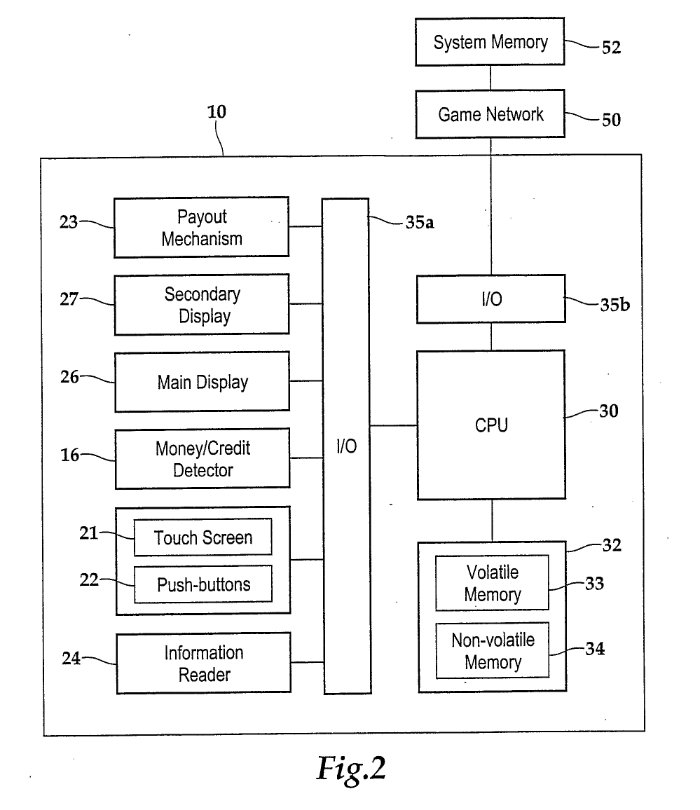

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

In some embodiments, the CPU 30 may not be inside the gaming terminal 10. Instead, the CPU 30 may be part of a game network 50 (FIG. 2) and may be used to control numerous gaming terminals 10. In these embodiments, the CPU 30 will run the basic games for each of the gaming terminals 10, and may also be used to link the gaming terminals 10 together. The game network 50 can include progressive jackpots that are contributed to by all or some of the gaming terminals 10 in the network (e.g., terminal-level jackpots that only each terminal 10 contributes to, bank-level jackpots that are contributed to by all of the terminals 10 in a particular bank, and wide-area jackpots that are contributed to by a larger number of terminals 10, such as multiple banks). Alternatively, the game network 50 can allow the player to retrieve assets obtained while playing one terminal 10 at a different gaming terminal that is also part of the game network. Assets may be any number of things, including, but not limited to, monetary or non-monetary awards, features that a player builds up in a bonus or progressive game to win awards, etc.

In some embodiments, the CPU 30 is also used with the information reader 24 to restore saved assets. For example, in one embodiment, the information reader 24 is adapted to receive and distribute tickets. The tickets each include a unique identifier. The unique identifier links the ticket to a file contained within the local memory 32 or a system memory 52 located in the game network 50. The file includes the assets that are being stored from a previous game. Monetary awards include game credits or money, while the non-monetary awards can be free plays (e.g., free spins), multipliers, or access to bonus and/or progressive games.

When a player inserts a ticket into the information reader 24, the CPU 30 obtains the unique identifier and causes the appropriate memory 32, 52 to be searched, and the file containing the unique identifier matching the identifier on the ticket is retrieved. Any assets or other information contained in this file are then transmitted to the gaming terminal 10, and the player regains any assets that were saved during a previous game. This allows the player to keep assets even after a particular gaming session ends, which increases player commitment to a game and decreases vulturing (and possibly even ends it).

In other embodiments, the information reader 24 may include a card reader, and the unique identifier provided at the gaming terminal 10 may be stored on a personal identification card, such as one described above. Or, the gaming terminal 10 includes a radio frequency identification device (RFID) transceiver or receiver so that an RFID transponder held by the player can be used to provide the unique identifier of the player at the gaming terminal 10 without the need to insert a card into the gaming terminal 10. RFID components can be those available from Pacific Northwest National Laboratory (under the United States Department of Energy) of Richland, Wash.

In other embodiments, the information reader 24 may include a biometric reader, such as a finger, hand, or retina scanner, and the unique identifier may be the scanned biometric information. Additional information regarding biometric scanning, such as fingerprint scanning or hand geometry scanning, is available from International Biometric Group LLC of New York, N.Y. Other biometric identification techniques can be used as well for providing a unique identifier of the player. For example, a microphone can be used in a biometric identification device on the gaming terminal so that the player can be recognized using a voice recognition system.

In other embodiments, the player may simply have to enter in a unique identification code and password into the gaming terminal 10. In these embodiments, the player would not have to insert a physical object (such as a card or ticket) into the gaming terminal, but would instead use the information reader 24 as an input device, such as a keyboard.

In summary, there are many techniques in which to provide a unique identifier for the player so that the assets accumulated by the player during one wagering session can be stored in either the system memory 52 or local memory 32, thereby allowing the player to subsequently access those assets at the same gaming terminal 10 or a different gaming terminal within the network 50. Various assets related to the wagering game features and formats can be stored after one gaming session and used in a subsequent gaming session(s) to enhance the gaming experience for the player.

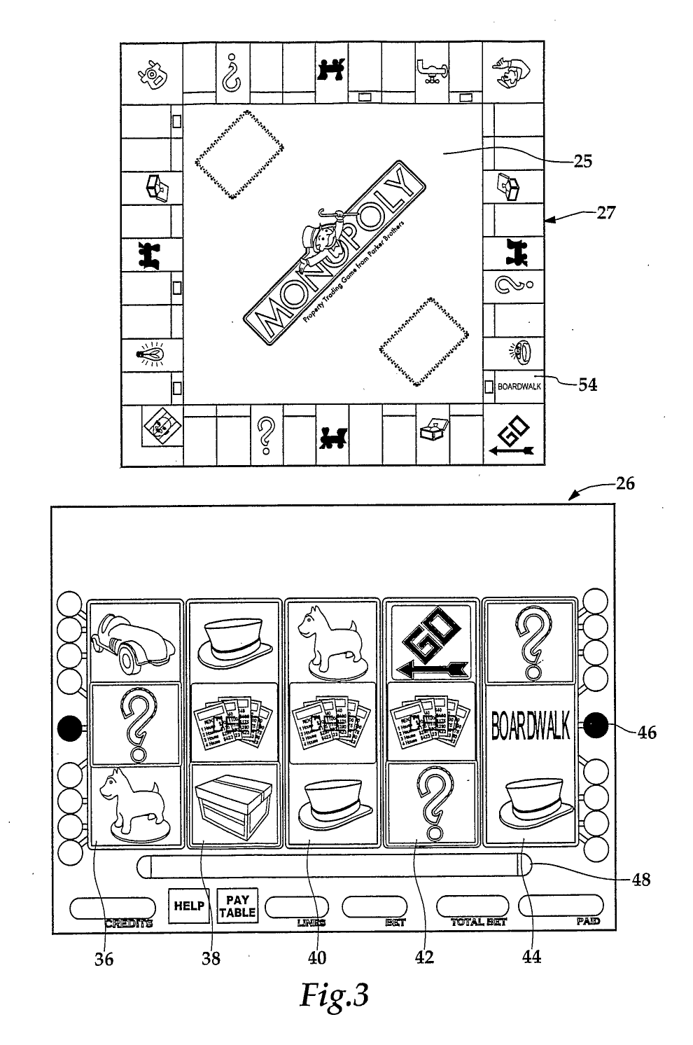

The main display 26 of one embodiment of the present invention is shown in more detail in FIG. 3. In this embodiment, the basic wagering game is a slot machine game, with symbols on five different reels 36, 38, 40, 42, 44. The reels 36-44 may be either traditional mechanical reels or they may be computer-generated images of reels, with each reel composed of a plurality of symbols. Upon receiving a wager input, the payline indicators 46 indicate a randomly selected outcome from a plurality of outcomes for each payline, which is the combination of symbols on the reels 36-44. Thereafter, an outcome indicator 48 indicates whether the outcome has resulted in a winning outcome or a non-winning outcome. While multiple paylines are shown, a gaming terminal 10 with a single payline will also work with the present invention.

The wagering game of the present invention includes a basic game that has a board game theme. The board game 25, as shown on the secondary display 27 of FIG. 3, is associated with different types of assets that can be collected by a player. The assets can include, but are not limited to, properties, utilities, railroads, and other items associated with a board game. In addition to the basic game, the wagering game can also include a bonus game. The bonus game may also have a board game theme. A player accumulates assets to gain, among other things, credits, free plays, and/or access to a bonus game and a bonus award. The accumulation of assets is affected by the randomly selected outcome of the basic wagering game. Upon termination of a gaming session, the accumulated assets can be selectively stored by the player in memory device for use in a later gaming session.

The wagering game, as depicted in FIG. 3, includes a board game 25 with a Monopoly™ theme. The symbols on the reels 38-44 indicate a winning combination along the center payline: three deeds on reels 38, 40, 42 and a Boardwalk™ symbol on reel 44. Based on this winning combination, a player is awarded a house and/or hotel on the Boardwalk™ property 54, indicating that he or she has collected that property, and now owns it. As shown on the secondary display 27 in FIG. 3, the Boardwalk™ property 54 and several other properties have houses and/or hotels.

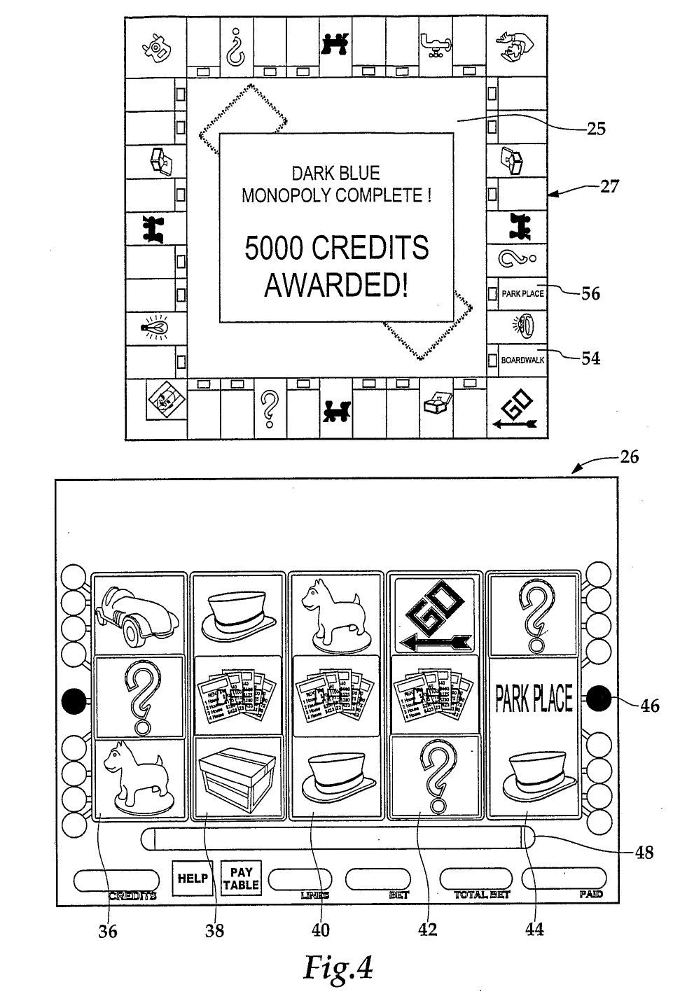

Following the Monopoly™ theme, the properties are grouped into sets of properties that are denoted by a specific color. For instance, Boardwalk™ and Park Place™ are “dark blue” properties. As shown on the board game 25 in FIG. 4, once a player collects a set of properties of the same color, he or she is given an award, i.e. 5000 credits. In FIG. 4, the player receives a Park Place™ symbol on reel 44, collects a house or hotel on the Park Place™ property 56, and thus, has now collected and owns all of the “dark blue” properties.

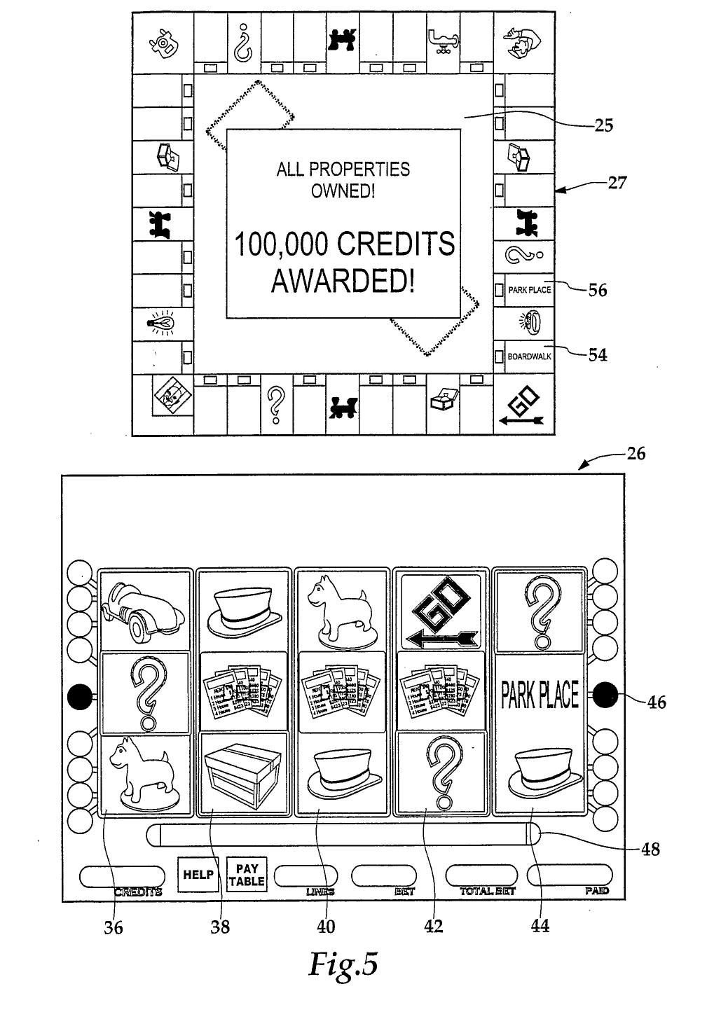

In one embodiment of the present invention, once a player collects all of the properties of the same color, i.e. a set, the player receives an award, and the properties are taken away from the player and the board game 25 is reset. In another embodiment, after a player gets an award for each set of properties that he or she collects, the properties are not taken away. Instead, the player continues to play with the existing properties that have been accumulated. If the player collects every property on the board game 25, including utilities and railroads, the player receives a larger award, as shown in FIG. 5, i.e. 100,000 credits. After receiving the award, all properties accumulated by the player are removed, i.e. all houses and/or hotels, and the board game 25 is reset.

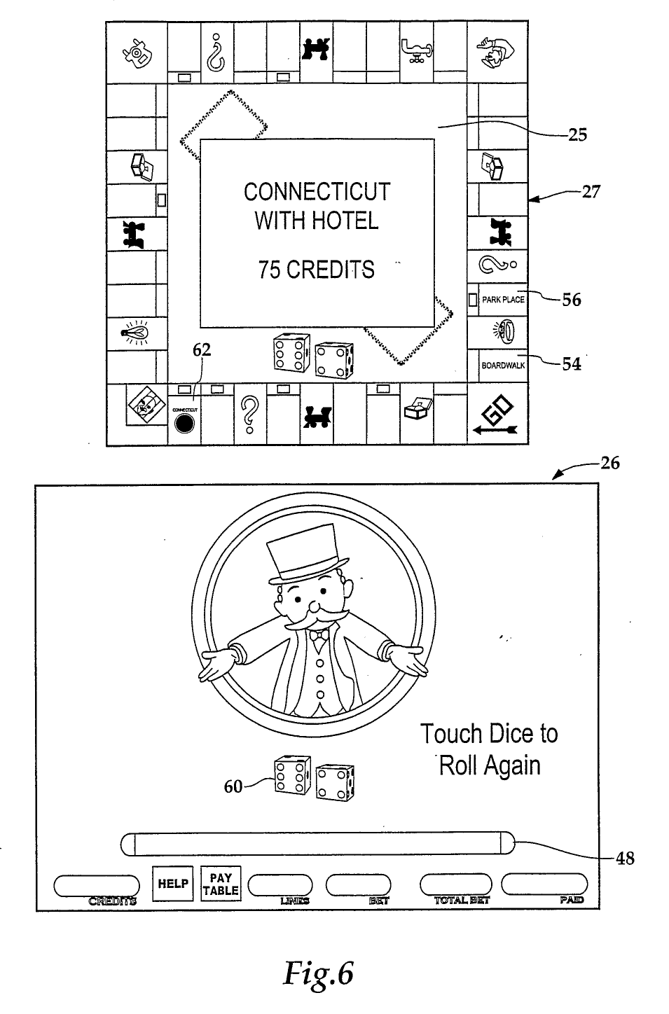

In another embodiment of the present invention, one of the randomly selected outcomes of the basic game includes a bonus-game outcome that awards a “Once Around” bonus. The bonus game is triggered by an outcome of the basic game that corresponds to a particular symbol combination. Once triggered, a player plays a round of “Once Around” in which he or she is allowed to roll the dice 60, as shown in FIG. 6, for one trip around the board game 25 in the hopes of winning a bonus award. If the player lands on properties with houses and/or hotels, then he or she may receive a larger award.

As shown in FIG. 6, the player has landed on the Connecticut property 62 containing a hotel, and is awarded 75 credits. After completing a “Once Around” bonus game or upon the occurrence of some other game-terminating event, all awarded properties are reset so that the player no longer owns the property. Alternatively, after completing a “Once Around” bonus game, the properties collected by the player may be saved for later bonus games in the hopes of collecting a complete set(s) of properties at the same or a later gaming session.

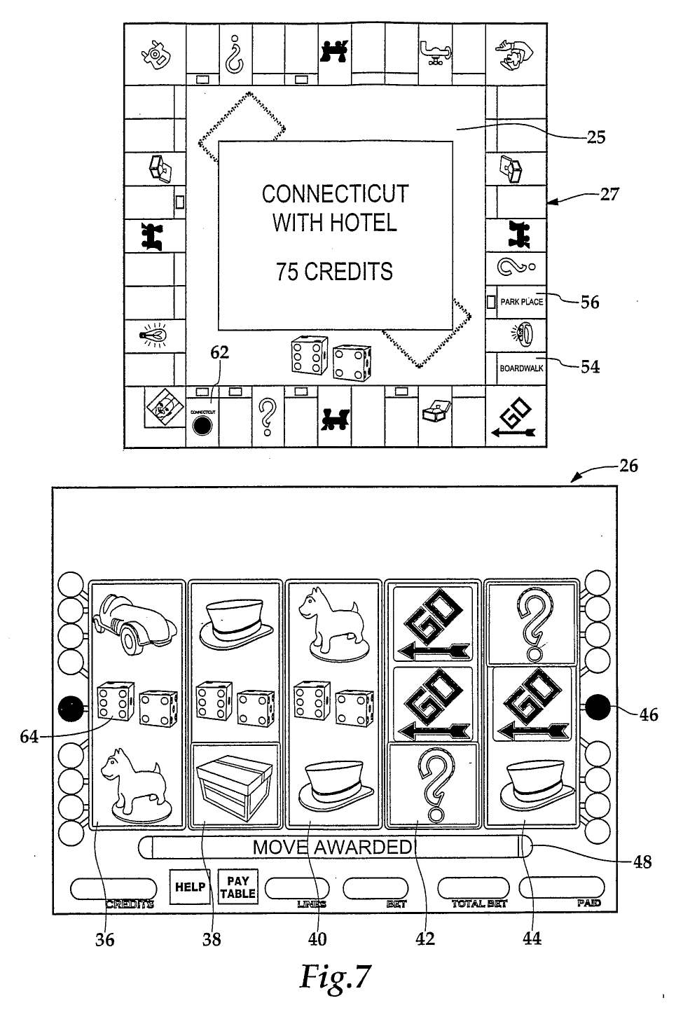

Similar to the embodiment described above, a bonus game may be triggered by a bonus-award outcome in the basic game that corresponds to a symbol combination as depicted in FIG. 7. Upon receiving three dice on a payline 64, a player may be awarded a bonus round where he or she is allowed to roll the dice, but instead of going all the way around the board game 25, the player's destination is set by the roll of two dice. The player's status, i.e. position on the board, is saved until the next time the bonus round is triggered by another bonus-award outcome. The player receives an award for each property landed on. A player receives a larger award for landing on a property that is owned by the player. Once awarded, the property is no longer owned by the player.

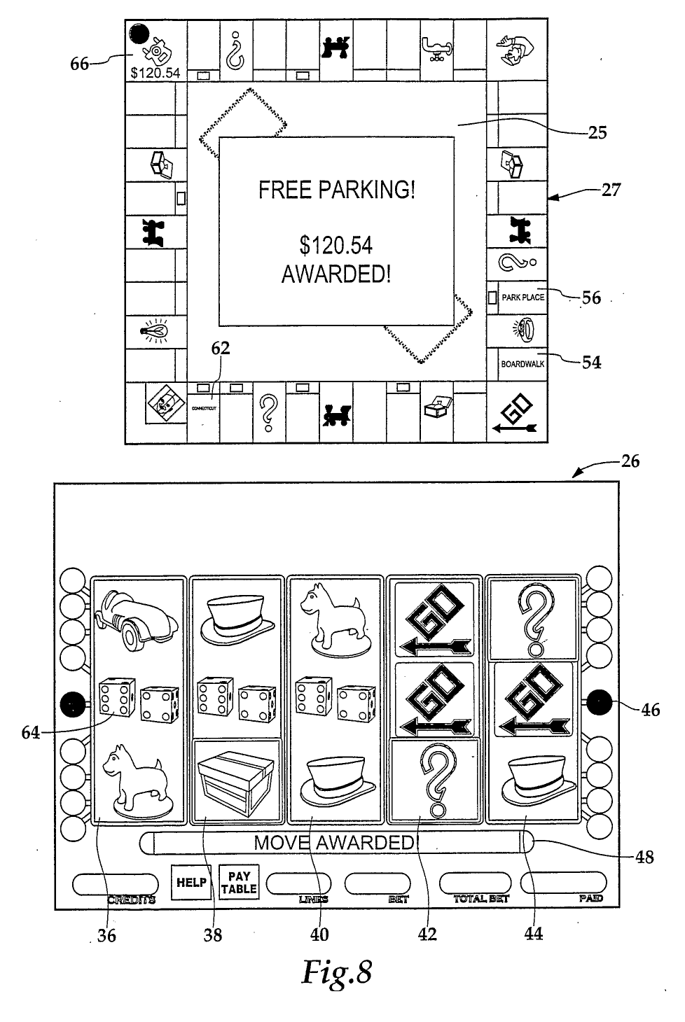

Another embodiment of the present invention includes a progressive award that is awarded upon a player receiving a progressive-award outcome. The progressive award is funded by a portion of a wager input. For example, every spin made by a player contributes 1% of the wager input into a “Free Parking” personal progressive. A player that lands on a Free Parking space 66, or achieves a symbol combination equivalent to landing on a Free Parking space 66, is awarded the progressive amount. FIG. 8 shows a progressive amount of $120.54 being awarded to a player who landed on the Free Parking space 66. The progressive award may be saved for a later gaming session in the hopes of increasing the amount of the award. One example of a personal progressive that can be used with respect to the present invention is described in U.S. patent application Ser. No. 60/502,762, entitled “Restricted Access Progressive Game for a Gaming Machine,” assigned to WMS Gaming, Inc., and is incorporated by reference herein in its entirety.

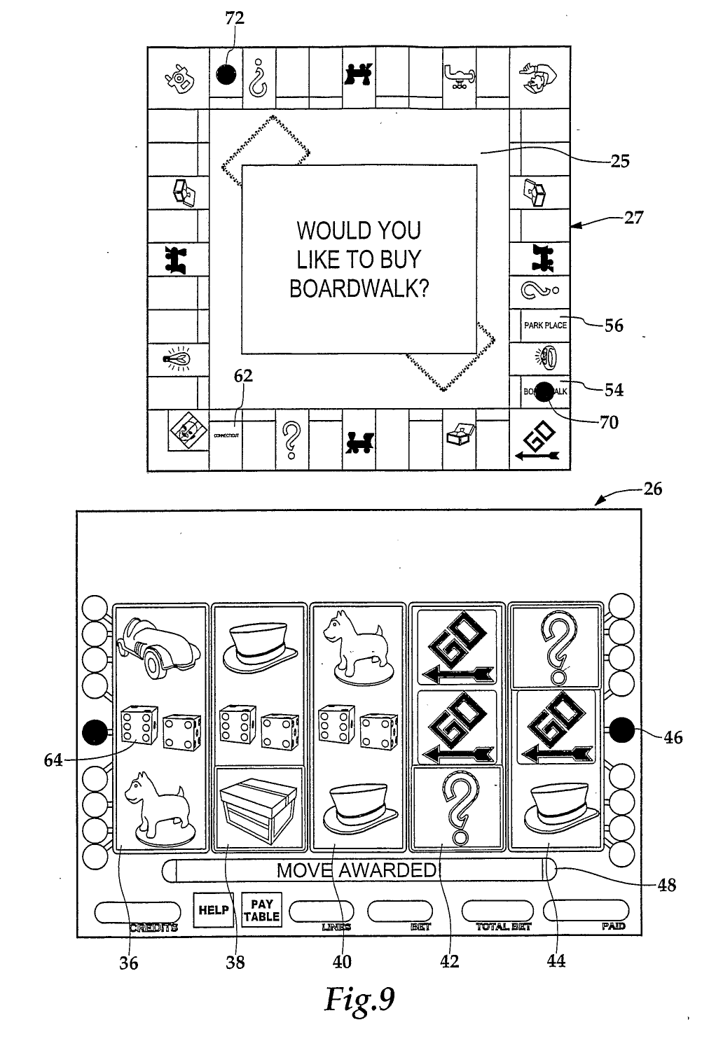

A further embodiment of the present invention, as depicted in FIG. 9, allows a player to play the board game 25 against a computer. In this embodiment, a player receives a certain symbol combination that corresponds to an outcome in the basic game that awards a move in the board game 25 that is played against the computer on the secondary display 27. FIG. 9 shows two tokens placed on two properties, one representing a player's token 70 and one representing the computer's token 72. The player is allowed to move around the board and receive awards, i.e. credits, that may be cashed out or saved to extend the length of the game and a chance to earn more awards. A player is also allowed to collect properties by being given the chance to buy a property on which he or she lands, such as is shown in FIG. 9 (“Would you like to buy Boardwalk?”). In one scenario, a player can “beat” the computer by acquiring more properties than the computer. In which case, a player may then be given an award.

Alternatively, a player may be allowed to play against another player, or a group of players. The player receiving the most assets, i.e., properties or sets of properties, may, for example, be awarded a bonus award of more credits, may be given his or her opponent's accumulated assets, or may be allowed to continue playing while the gaming session of the other player or players are terminated, or a combination of these or any other such award.

For each of the embodiments described above, after a player decides to terminate play at the gaming terminal, the accumulated assets, i.e. properties, utilities, railroads, tokens, dice, community chest cards, chance cards, etc., not exchanged by the player can be stored by the player in the local memory 32 or system memory 52, depending on the architecture and operation of the overall gaming system. The accumulated assets can then be restored for use in a subsequent gaming session by the player. For example, for the embodiment described in FIG. 3, a player can decide to end the gaming session and save the Boardwalk™ property in the hopes that when he or she returns for a later gaming session, he or she will be able to collect the Park Place™ property and receive a larger award for collecting a set of properties. The subsequent gaming session may be played at the same or a different gaming terminal as the first gaming session.

A player may also be allowed to save the status of a bonus game (or a basic wagering game) prior to completing a gaming session. For example, for the embodiment described in FIG. 9, a player can save his position on the board, i.e., on the Boardwalk™ property, and return to continue to play against the computer at a later time. In this case, after a player returns for a subsequent gaming session, the gaming terminal can receive an input from the returning player to start the wagering game at the same point as the status of the earlier gaming session. As described above, the subsequent gaming session may be played at the same or a different gaming terminal as the first gaming session.

As the present invention has been described in terms of a basic game and a bonus game, any assets accumulated in either the basic or the bonus game may be saved for later retrieval.

Other embodiments of the present invention may include a super-expanding token covering a plurality of spaces whereby a player is eligible to receive an award for other neighboring properties that the token “expands” on. Another embodiment may allow a player to collect “Get-Out-Of-Jail-Free” cards that may extend play when a player receives an otherwise game-terminating outcome. These features enhance a player's ability to win larger awards and continue game play.

Further embodiments include allowing a player to select a corner of the board game to start, allowing a player to select the dice of his or her choice, and allowing a player to personally select his or her own token(s). Additionally, embodiments of the present invention may include a wagering game that combines two board games together in a snake-like fashion, or a double-deck board game that has multiple levels. As these and other game features are introduced in the basic and bonus game, the level of player excitement increases.

In alternative embodiments, a player can use a telephone to access and use one or more of the player's accumulated game assets. For example, using a mobile phone, the player can dial a toll-free phone number to access his or her game assets. A central server associated with the network 50 (FIG. 2) can recognize the player's mobile number for identification purposes, via a caller-id feature, or, alternatively, the central server may require the player to create a unique code number (if, for example, the player uses a caller-id block feature). Optionally, the player may be required to enter an additional code for identifying a specific gaming machine 10.

Thus, the player can use his or her mobile phone to remotely access the wagering game and utilize the accumulated assets at a time and place according to the player's desire. For example, the player can restart a gaming session via the mobile phone at a point where he or she had previously stopped the session, or the player can choose, via the mobile phone, to play an accumulated bonus game that he or she had previously won, but not played.

In another example, the player can put money into a gaming machine 10 while the player is physically at the gaming machine 10. Before the player walks away from the gaming machine 10, the player can register the gaming machine 10 to the player's phone. The player can also let the gaming machine 10 know what assets it may intend to use in the future via remote access by the phone. For example, the player can register the phone number as a password required to access the player's assets on the gaming machine 10. The player can initiate an auto-play feature while at the gaming machine 10 or remotely via the phone. The auto-play feature of the gaming machine 10 is configured to report, e.g., via still or moving images on the phone, one or more of the gaming outcomes. Then, at a later time, the player returns to the gaming machine 10, re-checks into the gaming machine via the phone and, optionally, cashes out any winnings. While no actual gameplay occurs on the phone, the phone is used for accessing the player's assets and gaming outcomes on the gaming machine 10.

Optionally, the wagering game provides the player with access to accumulated assets and/or certain awards only if the player achieves a “Remote Play Winning Outcome.” If the player achieves this outcome (e.g., in a basic or bonus game), then he or she is allowed remote access to one or more of the accumulated assets and/or certain awards. For example, if the player achieves the “Remote Play Winning Outcome,” the player can have the option to select a smaller award while the player is physically present at the gaming machine 10 or a larger award if the player uses the telephone. In another example, the player may be given the option to play for smaller awards while the player is physically present at the gaming machine 10 or for larger awards if the player uses the telephone for gameplay initiation.

Alternative to using a voice telephone call to initiate a game or to access assets and/or awards, as described above, the player can send a text message. For example, the player can send a special code in the text message to log-in using a special number on the gaming machine 10.

For identification purposes, various verification ways can be used. For example, the player can enter the mobile telephone number into the gaming machine 10 as a player identification number. When the phone is near, the gaming machine 10 can detect it and verify the player identification number, e.g., the mobile number. For example, a receiver can be installed in the gaming machine 10 for detecting a mobile identifier (which may include the mobile number) that is periodically transmitted by mobile phones to the nearest mobile base station. Thus, the gaming machine 10 would have similar capabilities to the mobile base station.

Alternatively, the gaming machine 10 can send a voice or text message to the mobile telephone to verify the player's identification number. For example, the gaming machine 10 can send a text message asking the player to reply to the text message using a predetermined code for confirmation purposes. Optionally, a Bluetooth identifier can be used for logging-in and/or verification purposes, wherein the Bluetooth identifier is unique per phone and/or service carrier.

Special benefits can be offered to a player based on the telephone brand and/or service carrier. For example, predetermined assets can be made available to the player only if they use a telephone of brand X that uses service carrier Y. Optionally, the special benefits can be made available based on the telephone model.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A gaming terminal for playing a wagering game, comprising:
a basic game having a plurality of symbols that indicate a randomly selected outcome that has been selected from a plurality of outcomes in response to a wager input, said plurality of outcomes including assets of a board game that are accumulated by a player of said basic game;
a bonus game having a bonus award based on an accumulation of at least one of said assets, said accumulation of at least one of said assets being affected by said randomly selected outcomes in said basic game; and
wherein, in response to a termination of a gaming session, said accumulation of assets being selectively stored by said player in a memory device for use in a subsequent gaming session by said player.

2. (canceled)

3. (canceled)

4. The gaming terminal of claim 1, wherein said bonus award is based on said accumulation of a set of said assets in said basic game.

5. The gaming terminal of claim 4, wherein after awarding said bonus award, said set of said assets is removed from said player's accumulation of assets.

6. (canceled)

7. (canceled)

8. The gaming terminal of claim 1, wherein one of said randomly selected outcomes is a bonus-award outcome.

9. The gaming terminal of claim 8, wherein said bonus-award outcome allows said player to receive said bonus award based on assets accumulated in said basic game.

10. (canceled)

11. (canceled)

12. The gaming terminal of claim 8, wherein said bonus-award outcome includes allowing said player to continue to play until a game-terminating event occurs.

13. The gaming terminal of claim 1, wherein said bonus game allows said player to save a status of said bonus game.

14. The gaming terminal of claim 13, wherein said status is restored when said player receives a second bonus-award outcome.

15. (canceled)

16. (canceled)

17. The gaming terminal of claim 1, wherein one of said plurality of outcomes includes game play against a computer.

18. The gaming terminal of claim 1, wherein one of said plurality of outcomes includes game play against another player or a group of players.

19. (canceled)

20. (canceled)

21. (canceled)

22. (canceled)

23. A method of playing a wagering game having a basic game and a bonus game, comprising:
conducting said basic game at a gaming terminal, said basic game having a plurality of symbols that indicate a randomly selected outcome that has been selected from a plurality of outcomes in response to a wager input, said plurality of outcomes including assets of a board game that are accumulated by a player of said basic game;
achieving a bonus-game outcome in said basic game, said bonus game providing a bonus award based on an accumulation of said assets during said basic game;
receiving inputs from a player to save said assets prior to said player completing a gaming session; and
storing said assets in a memory device for use in a subsequent gaming session.

24. (canceled)

25. (canceled)

26. (canceled)

27. (canceled)

28. (canceled)

29. (canceled)

30. The method of claim 23, wherein one of said randomly selected outcomes is a bonus-award outcome.

31. The method of claim 30, wherein said bonus-award outcome allows said player to receive said bonus award based on assets accumulated in said basic game.

32. The method of claim 31, wherein said assets accumulated in said basic game are associated with awards of different values in said bonus game.

33. (canceled)

34. The method of claim 30, wherein said bonus-award outcome includes allowing said player to continue to play until a game-terminating event occurs.

35. The method of claim 23, wherein said bonus game allows said player to save a status of said bonus game.

36. The method of claim 35, wherein said status is restored when said player receives a second bonus-award outcome.

37. The method of claim 23, wherein one of said assets of said basic game includes a progressive award, said progressive award being funded by a portion of said wager input from said basic game.

38. The method of claim 37, wherein said progressive award is awarded to a player upon receiving a progressive-award outcome in said basic game.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. A method for conducting a wagering game, comprising:
receiving a wager input from a player for playing a wagering game during a first gaming session, said wagering game having a board game theme;
selecting at least one randomly-selected outcome of a plurality of outcomes in response to said receiving a wager input;
allowing a player to acquire at least one of a plurality of assets associated with said board game;
selectively storing said assets in a memory device for use in a second gaming session; and
in response to playing said second gaming session of said wagering game, restoring said assets from said first gaming session for use in said second game session.

64. The method of claim 63, wherein said wagering game includes a basic game and a bonus game, said bonus game including a bonus award based on assets accumulated in said basic game.

65. The method of claim 64, wherein said bonus game allows said player to save a status of said bonus game, said status being restored when said player receives a bonus-award outcome.

66. The method of claim 65, wherein said bonus-award outcome allows said player to receive more than one bonus award.

67. The method of claim 65, wherein said bonus-award outcome allows said player to continue playing until a game-terminating event occurs.

68. (canceled)

69. (canceled)

70. (canceled)
